(19) United States
(12) Patent Application Publication
(10) Pub. No.: US 2018/0205559 A1
(43) Pub. Date: Jul. 19, 2018

(54) METHOD AND APPARATUS FOR AUTHENTICATING A SERVICE USER FOR A SERVICE THAT IS TO BE PROVIDED

(71) Applicant: SIEMENS AKTIENGESELLSCHAFT, München (DE)

(72) Inventor: JENS-UWE BUßER, NEUBIBERG (DE)

(21) Appl. No.: 15/743,706

(22) PCT Filed: May 19, 2016
(86) PCT No.: PCT/EP2016/061261

§ 371 Date: Jan. 11, 2018

(30) Foreign Application Priority Data
Jul. 14, 2015 (DE) 10 2015 213 180.7

(51) Int. Cl. H04L 9/32; G06F 21/62

(52) U.S. Cl. CPC H04L 9/3268; G06F 21/6263; H04L 9/3255

(57) ABSTRACT

A method and an apparatus for authenticating a service user for a service that is to be provided. The method has the following steps: a) provision of an anonymous and self-signed certificate, produced by a service use means of the service user, for set-up of a connection, protected by the use of a security protocol, for data transmission between the service use device which is for example, a mobile device or a PC, via his anonymous, self-signed certificate and a service provision device, for example, a server, at the application level using the group signature, and b) verification of the provided anonymous and self-signed certificate by means of a group signature, assigned to a group, for detecting the authorization of the service user to use the service, in order to establish whether the service user providing the certificate through his service use device is a member of the group.

### CROSS-REFERENCE TO RELATED APPLICATIONS

This application claims priority to PCT Application No. PCT/EP2016/061261, having a filing date of May 19, 2016, based on German Application No. 10 2015 213 180.7, having a filing date of Jul. 14, 2015, the entire contents both of which are hereby incorporated by reference.

### FIELD OF TECHNOLOGY

The following relates to a method and a device for authenticating a service user for a service that is to be provided, which can be provided by a service provision means and can be accepted by a service use means used by the service user.

### BACKGROUND

Most of the items in daily use (food, clothing, magazines and books, fuel, etc.) as well as many services (travel by public transport, railway or taxi, restaurant and hairdresser visits, etc.) can be paid for with cash and therefore be used quasi-anonymously. Many free services on the internet can also be used anonymously, because for the service provision, knowledge of the identity of the service user is usually not necessary. On the other hand, when using cashless payment by a cash card (also designated as a debit card) or credit card, the identity of the customer or service user is known to the seller. Even in processes such as payment card or payment via smartphone, the seller is at least aware of a pseudonym with which he can recognize a customer.

When a pseudonym is used for a service user, it is possible to determine the true identity of a person from knowledge of the assignment of the pseudonym to the civil name, but this is usually known only to a very limited group of persons. Examples of pseudonyms: “User 77”, phone number, IP address of domestic IP connection, e-mail address, etc. Pseudonyms can be revealed, for example, on request to the telephone/IP service provider. Billing of services is possible with pseudonyms if the pseudonym is associated with a billing account.

Different activities can be assigned to a single person, if they use the same pseudonym multiple times. This can be used to create behavioral profiles (e.g. movement profiles) by service providers, or in certain applications even lead to an undesirable exposure of the pseudonym, for example if the service user uses the same pseudonym for paying for a taxi ride home via smartphone as for other applications, such as the use of internet services/browsing with the same pseudonym. No pseudonym can be used to protect a person's anonymity. The true identity of a person cannot be detected, or only with a disproportionate amount of effort. It cannot be readily determined whether different activities are carried out by the same person.

To enable anonymity for simple payment transactions and other services, including electronic booking and use of services, would require an authentication of the service user by means of group signatures.

A group signature, such as is known from DE 10 2012 221 288 A1 in connection with the use of electricity charging columns for electric cars or car sharing services, allows each member of a group to digitally sign a message as a member of a group. Each member of the group has their own private key, and can therefore generate a group signature. The respective member remains anonymous with respect to the recipient of the signed message. A verifier has a corresponding public group key, by means of which he can check the signature of a message generated by a member of a group. However, the verifier receives no information at all as to which member of the group has created the signature and therefore the message. If the verifier receives two signed messages, then he still cannot determine whether these have been signed by two different members of the group, or whether both messages were signed by the same member of the group.

A group signature method preferably comprises at least the following steps:

1. The function “GKg” creates three keys: keyOpen, keyIssue and keyVerify.
2. The keyIssue key is disclosed to an authority. This authority has the function “Join”, which creates the private keys dynamically from keyIssue for members of a group (keySSi). A new member may digitally sign any messages “m” in the name of the group: sig(m)g.
3. The function “GVrfy” checks using the keyVerify, m, sig(m)g the group membership of the signature creator i. If the membership is confirmed, then a resource can be released to the signature creator i.
4. In case of a dispute, then another authority, different from the authority mentioned under point 2, can assign a signature sig( )g to a member i using the function “open”. The functions keyOpen, sig(m)g and m are used for this purpose.

Various cryptographic procedures provide different functions, for example
Non-identifiability of the service user by the recipient. Only an examination of the group membership is possible.
Retrospective identification by an independent agent, for example, to investigate possible misuse.
Revocation of the group membership of individual service users

An anonymous charging of services is easily possible with group signatures if the user authenticates himself with respect to the service provider by an anonymous group signature, and only an independent accounting center opens the group signatures to identify the user retrospectively for settling the bill.

A group comprises in particular the set of authorized service users. A group can be, for example, the set of customers of a service provider or a billing company, the citizen of a State, the member of a company's staff, the member of an association, and so on. Groups can be shared and merged with other groups to form new groups.

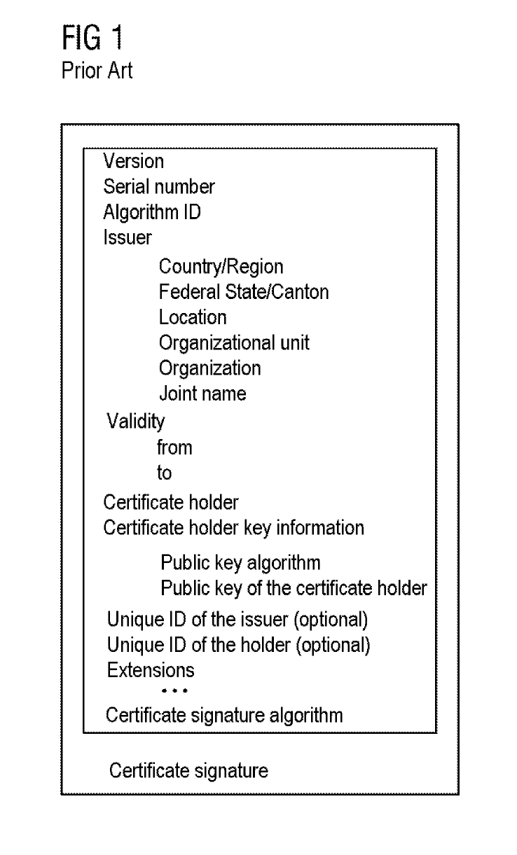

Various cryptographic procedures are known, such as asymmetric encryption and signature. This is based on the use of a related key pair, wherein a public key is used for encryption and signature verification and a private key is used for decryption and signature generation. In the case of authentication methods for secure protocols such as TLS (Transport Layer Security) and IPsec (Internet Protocol Security), for example, a mutual authentication is possible between the client and the server with certificates. The certificate is used to assign a particular public key to a user. This assignment is accredited by a third-party certification body by providing it with their own signature. Widely used public-key certificates are those in accordance with the X.509 standard, which confirm the identity of the holder or user and other properties of a public cryptographic key. FIG. 1 shows an example of the structure of the standardized X.509 certificate version 3.

The group signature procedure mentioned earlier cannot be used in conjunction with standardized protocols such as TLS and IPsec, because these only support defined signature methods (for example, RSA, DSA, Elliptic Curve DSA, etc.).

### SUMMARY

An aspect relates to an improved anonymous authentication of a service user for a service that is to be provided.

Embodiments of the invention claim a method for authenticating a service user for a service to be provided or rendered, having the following steps:

a) provision of an anonymous and self-signed certificate, produced by a service use means of the service user, for establishing a connection secured by the use of a security protocol, for data transmission between the service use means and a service provision means, and
b) verification of the provided anonymous and self-signed certificate by a group signature assigned to a group, for verifying the authorization of the service user to use the service, in order to ascertain whether the service user providing the certificate through his service use means is a member of the group.

The service in this case can be provided by a service provision means, which can be implemented by a service provider in the form of a server or similar. The authenticated service user can request the service from the service provision means.

In this case, in other words, for establishing the connection via standard secure protocols, anonymous standard certificates, which can also be short-lived, such as TLS and IPSec, can be combined with anonymous group signatures, which at first only prove the membership of the service user in a group. An identification of the service user by an independent third party (e.g. an accounting center) is also possible. In this case, in accordance with embodiments of the invention the certificate used is not signed by a certification body, but by the service user himself.

With the procedure according to embodiments of the invention, the use of the previous certificate standard and the existing stack implementations of security protocols such as TLS and IPsec is possible, since the creation and checking of the group signature can be carried out in the application.

This means that the service user, or the service use means being used by the user, which can be implemented in the form of a (mobile) device or a computer, is not known to the service provision means. Even in the case of different service uses by the same service user, the service provision means cannot determine whether the same service user is involved. A non-data-protection compliant tracking of the usage behavior is thereby prevented. On the other hand, the service user name and the cost of the billed services are known to the accounting center, but not which kind of service has been provided.

An extension of embodiments of the invention provides that step b) above is repeated one or more times using a further group signature assigned to the group as proof of the authorization of the service user to use an additional service.

An extension of embodiments of the invention provides that the authenticated service user requests one or more additional services from the service provision means.

An extension of embodiments of the invention provides that the connection is terminated.

An extension of embodiments of the invention provides that the anonymous certificate is deleted after a single use.

An extension of embodiments of the invention provides that the one group signature or the additional group signatures assigned to the group are transferred to an accounting center for each billing operation for billing the one or more services requested.

An extension of embodiments of the invention provides that the aforementioned TLS or the aforementioned IPsec protocol is used as the secure protocol.

An extension of embodiments of the invention provides that the X.509 certificate format is used as the format of the certificate.

An extension of embodiments of the invention provides that at least part of the certificate, in particular the public key or the signature thereof, or the complete certificate, or the fingerprint of at least part of the certificate or the fingerprint of the whole certificate are incorporated into a group signature.

An extension of embodiments of the invention provides that, if part of the certificate or the fingerprint of at least part of the certificate or the fingerprint of the complete certificate are incorporated in the group signature, then this group signature is transmitted separately from the at least one remaining part of the certificate.

An extension of embodiments of the invention provides that the group signature is integrated in at least one certificate extension field.

A further aspect of embodiments of the invention is an apparatus suitable for authenticating a service user for a service to be provided, having:

means for providing an anonymous and self-signed certificate, produced by a service use means used by the service user, for establishing a connection for data transmission secured by the use of a security protocol, wherein the certificate can be used for authentication by means of a group signature assigned to a group, for verifying the authorization of the service user to use the service in order to ascertain whether the service user providing the certificate through his service use means is a member of the group.

A further aspect of embodiments of the invention is a service use means, which is implemented with the above-mentioned apparatus.

An extension of the apparatus provides means for delivery or performance of the service requested by the authenticated service user.

An extension of the apparatus provides means for the above-mentioned authentication of the anonymous and self-signed certificate provided.

A further aspect of embodiments of the invention is a service provision means capable of providing a service, which can be designed according to the above extension of the apparatus according to embodiments of the invention. The above apparatus and service provision means and service use means for authenticating a service user have means or units or modules for carrying out the above-mentioned method, wherein these can each be based on hardware and/or software, or can be in the form of a computer program or a computer program product (non-transitory computer readable storage medium having instructions, which when executed by a processor, perform actions).

A further aspect of embodiments of the invention can be a computer program or a computer program product, having means for carrying out the method and its identified configurations, if the computer program (product) is embodied on at least one of the above-mentioned items of apparatus and/or service provision means, which can be configured as mentioned above.

The above apparatus and service provision means and service use means and, if appropriate, the computer program (product), can be extended in the same way as the method and its embodiments or extensions.

One or more exemplary embodiments of the invention

### BRIEF DESCRIPTION

Some of the embodiments will be described in detail, with references to the following figures, wherein like designations denote like members, wherein:

FIG. 1 the above-mentioned structure of an X.509 v3 certificate;

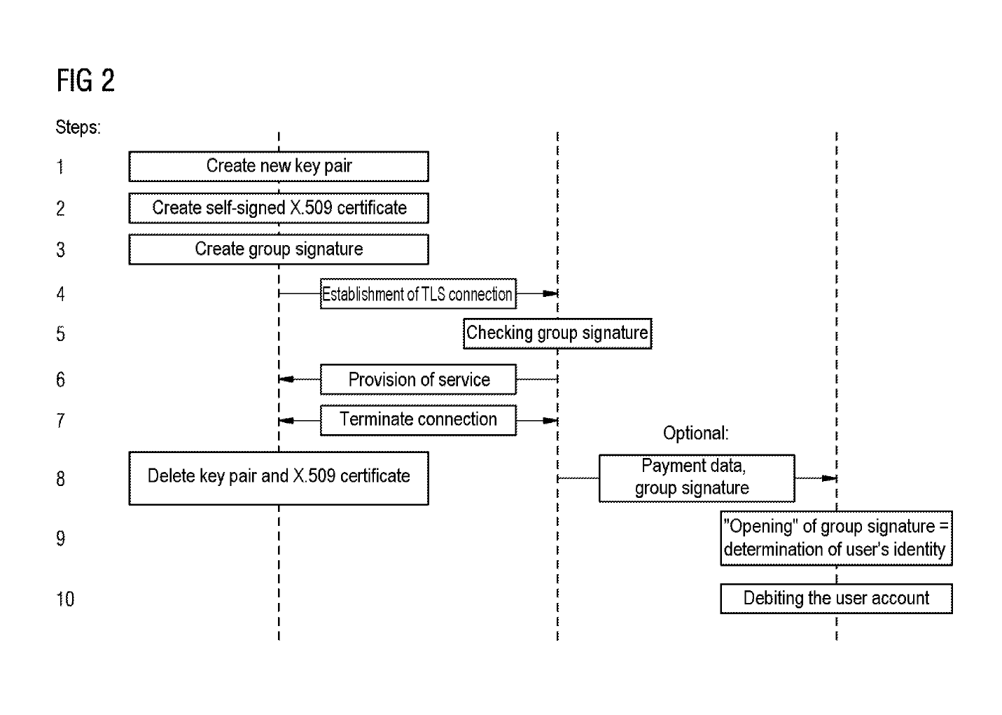

FIG. 2 a schematic flow chart of an exemplary embodiment of the method according to embodiments of the invention;

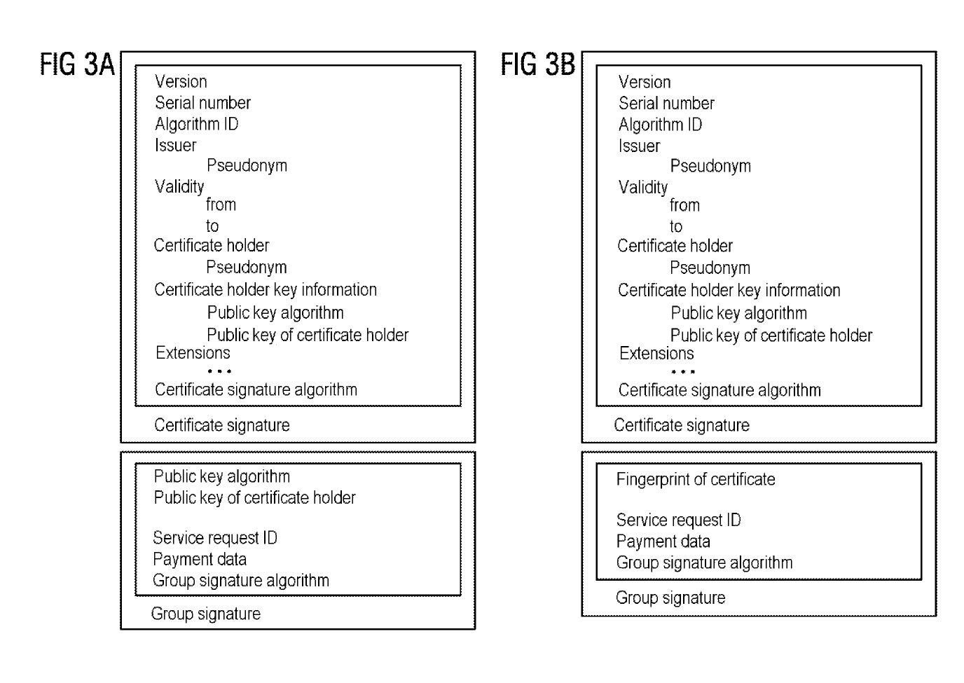

FIG. 3a an example of a self-signed X.509 certificate by means of a group signature by way of the public key used;

FIG. 3b an example of a self-signed X.509 certificate by means of a group signature using the fingerprint of the certificate;

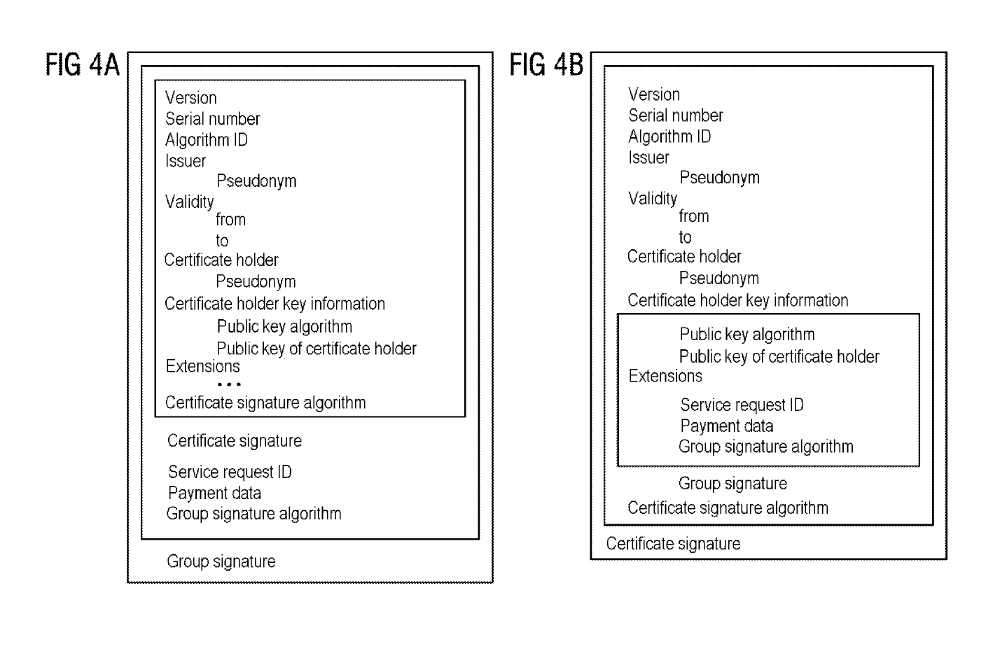

FIG. 4a an example of an X.509 certificate incorporated into a group signature; and

FIG. 4b an example of an X.509 certificate with a group signature using several certificate fields as an X.509 certificate extension.

### DETAILED DESCRIPTION

In the figures, the same or functionally equivalent elements have been provided with the same reference numerals, unless otherwise indicated. FIG. 2 shows individual method steps in the lines marked with the numbers 1 to 10.

FIG. 2 shows a schematic flow chart of an exemplary embodiment of the method between a service user who uses a service use means N, the service provision means D used by the service provider, and a third party, preferably an accounting center A.

In step 1 the service user of an electronic, possibly chargeable service first creates a new key pair for an anonymous and standards-compliant certificate for anonymous use of a service. In step 2, the certificate is created by the service user. The certificate in this case is self-signed. In this example, the self-signed certificate can be short-lived, i.e. it is only valid for a short period of time, for example, a couple of minutes, hours or 1 day, depending on the type of service to be used. In step 3, the proof that this self-signed certificate originates from a member of the (customer) group of the service provider, is obtained by the service user upon creating a group signature. In establishing the connection in step 4 with a security protocol (e.g. TLS), a reciprocal authentication takes place with certificates in the so-called Security Protocol Stack. The service provider authenticates itself via its server certificate. The service user authenticates himself using his service use means N, for example, a mobile device or a PC, via his anonymous, self-signed certificate. In step 5, based on the anonymous certificate, the service provider will also verify the membership of the service user in his group using its service provision means, for example a server, at the application level using the group signature. In step 6, the service provider provides the desired service to a service user.

In step 7, after the provision of the service, the connection is terminated and the user deletes the key pair and certificate in step 8. Optionally, the service provider forwards the group signature and the (billing and/or payment) data signed with the group's signature to an independent accounting center A, which “opens” the group signature in step 9, thereby identifying the service user and charging him for the service used in step 10.

Optionally, after the service provision the service user can also maintain the connection, in order to request and receive at least one further service, possibly with the same certificate. The connection is terminated when all desired services have been provided.

An advantage of the described method is that the functions of conventional implementations can continue to be used. Only the production (on the service user side) or checking (on the service provider side) of the group signature are added into the application; however, the service can be used anonymously and yet be billed by an independent agent based on consumption.

The group signature protects at least the public key of the certificate, preferably the X.509 certificate, against unauthorized changes. The group signature thus extends, for example, to cover
the public key (see FIG. 3a) or
the fingerprint (hash) of the public key (not shown) or
the signature of the certificate (not shown) or
the fingerprint (hash) of the certificate (see FIG. 3b) or
the whole certificate (see FIG. 4a).

The outer frames of FIGS. 3a, 3b, 4a and 4b refer to a self-contained data structure, such as a file. Inner frames contained therein relate in each case to the area of the file which is protected with respect to integrity and authenticity by the signature directly given under each one.

In addition, it is recommended that other information, such as a unique identification (ID) of the service request, if appropriate, payment-relevant data content, for example regarding price and extent/duration of service, and information that should appear on the service user's bill (e.g. time/duration of service), are also protected by the group signature.

The ID of the service request should not be generated by the user in a consecutive order, but randomly (e.g. by using a hash function of a random number), to prevent any assignment of different service requests from the same service user by the service provider.

In the case of a free service, which is to be offered to only a restricted group of users, a payment value of “0” can be entered. The transfer to the accounting service can then be omitted.

All other data which are either not intended or not allowed to be passed to the accounting center, are transferred outside of the group signature. This can happen within the X.509 certificate, but only if this is not included within the group signature (see FIG. 4a). Otherwise, this data can also be transferred via the secure connection of the security protocol.

Implementations of security protocols (e.g. TLS) expect standardized certificates, such as X.509 certificates. If these are surrounded by a group signature, as shown in FIG. 4a, then standard implementations of the TLS stack cannot handle them. Therefore, for interoperability reasons, it is more advantageous to separate the group signature from either the X.509 certificate, as shown for example in FIGS. 3a and 3b, or to integrate the group signature in the X.509 certificate as an extension field (see FIG. 4b). In particular, the variant shown in FIG. 4b allows the integration of a group signature and other parameters, which are protected by the group signature, into a conventional, standardized certificate. If the group signature is included in the standardized certificate, it will be calculated prior to the signature of the certificate. In this case, the sequence of creating the certificate (step 2) and creation of the group signature (step 3), marked in FIG. 2 as step 2, 3, is reversed.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A method for authenticating a service user for a service to be provided, having the following steps:
a) provision of an anonymous and self-signed certificate, produced by a service use means of the service user, for establishing a connection, protected by the use of a security protocol, for data transmission between the service use means and a service provision means, and
b) verification of the provided anonymous and self-signed certificate by means of a group signature assigned to a group, as proof of the authorization of the service user to use the service, in order to ascertain whether the service user providing the certificate through his service use means is a member of the group.

2. The method as claimed in claim 1, wherein the service is provided by the service provision means.

3. The method as claimed in claim 1, wherein the authenticated service user requests the service from the service provision means.

4. The method as claimed in claim 1, wherein step b) of claim 1 is repeated one or more times using a further group signature assigned to the group for proof of the authorization of the service user to use an additional service.

5. The method as claimed in claim 2, wherein the authenticated service user requests one or more additional services from the service provision means.

6. The method as claimed in claim 1, wherein the connection is terminated.

7. The method as claimed in claim 1, wherein the anonymous certificate is deleted.

8. The method as claimed in claim 1, wherein the one group signature or the additional group signatures assigned to the group are in each case transferred to an accounting center for a billing operation for billing the one or more services requested.

9. The method as claimed in claim 1, wherein the security protocol used is the TLS or IPsec protocol.

10. The method as claimed in claim 1, wherein the X.509 certificate format is used for the certificate.

11. The method as claimed in claim 1, wherein at least a part of the certificate, including at least one of the public key the signature thereof, the complete certificate, or the fingerprint of at least a part of the certificate, or and the fingerprint of the whole certificate is incorporated into a group signature.

12. The method as claimed in claim 1, wherein, if part of the certificate or the fingerprint of at least part of the certificate or the fingerprint of the full certificate are incorporated in the group signature, then this group signature is transmitted separately from the at least one remaining part of the certificate.

13. The method as claimed in claim 1, wherein the group signature is integrated in at least one certificate extension field.

14. An apparatus for authenticating a service user for a service to be provided, having:
a) means for providing an anonymous and self-signed certificate, produced by a service use means of the service user, for establishing a connection for data transmission, protected by the use of a security protocol,
b) wherein the certificate can be used by a group signature assigned to a group, for verifying the authorization of the service user to use the service, in order to ascertain whether the service user providing the certificate through his service use means is a member of the group.

15. The apparatus as claimed in claim 14, characterized by means for the above-mentioned authentication of the anonymous and self-signed certificate provided.

16. The apparatus as claimed in claim 14, wherein the service is provided by a service provision means.

17. The apparatus as claimed in claim 14, wherein the one group signature or the additional group signatures assigned to the group are transferred in each case to an accounting center for a billing operation for billing the one or more services requested.

18. The apparatus as claimed in claim 14, wherein the TLS or IPsec protocol can be used as the security protocol.

19. The apparatus as claimed in claim 14, wherein the X.509 certificate format is used for the certificate.

20. The apparatus as claimed in claim 14, wherein at least part of the certificate, including at least one of the public key, the signature thereof, the complete certificate, the fingerprint of at least part of the certificate, and the fingerprint of the whole certificate are incorporated into a group signature.

21. The apparatus as claimed in claim 14, wherein if part of the certificate or the fingerprint of at least part of the certificate or the fingerprint of the full certificate are incorporated in the group signature, then this group signature is transmitted separately from the at least one remaining part of the certificate.

22. The apparatus as claimed in claim 14, wherein the group signature is integrated in at least one certificate extension field.

23. A service use means having a device as claimed in claim 14.

24. A service provision means having an apparatus as claimed in claim 15.
